(19) United States
(12) Patent Application Publication
(10) Pub. No.: US 2012/0045604 A1
(43) Pub. Date: Feb. 23, 2012

(54) BIODEGRADABLE FILM WITH PRESSURE-SENSITIVE ADHESIVE LAYER

(75) Inventors: Thierry Gavel, Brussels (BE); Wayne Middleton, Wigton (GB); Veli Nasib, Espoo (FI); Gianpaolo Faletti, Brussels (BE)

(73) Assignee: INNOVIA FILMS LIMITED, Wigton (GB)

(21) Appl. No.: 13/205,128

(22) Filed: Aug. 8, 2011

Related U.S. Application Data
(63) Continuation-in-part of application No. 12/222,498, filed on Aug. 11, 2008.
Application No. 12/222,498 is a division of application No. 10/471,694, filed on May 24, 2004, now Pat. No. 7,687,125.

(30) Foreign Application Priority Data
Mar. 15, 2001 (GB) 0106410.4

(51) Int. Cl. C09J 7/02; B32B 23/00; B32B 27/00; B32B 37/15; B32B 15/00; C09J 133/04; C09J 133/08; B32B 33/00; C09J 103/02

(52) U.S. Cl. 428/41.8; 428/343; 428/354; 428/355 AC; 428/355 CP; 428/344; 156/244.11

(57) ABSTRACT

A multi-layer, biodegradable film is disclosed. The multi-layer, biodegradable film contains a biodegradable core layer and a biodegradable pressure sensitive adhesive layer. The film may further contain a biodegradable, printable layer and a release liner.

This application is a continuation-in-part application of U.S. patent application Ser. No. 12/222,498, filed on Aug. 11, 2008, which is a divisional application of U.S. patent application Ser. No. 10/471,694, filed on May 24, 2004, now U.S. Pat. No. 7,687,125, which is a national entry of PCT/EP02/02726, filed on Mar. 13, 2002, which claims priority of Great Britain Application No. GB0106410.4, filed on Mar. 15, 2001. The entirety of all of the aforementioned applications is incorporated herein by reference.

### FIELD

The present application relates to a biodegradable, multi-layer film with a pressure-sensitive adhesive layer.

### BACKGROUND

Pressure-sensitive adhesive films can be conventionally fixed onto an article and are widely used as labels. Double sided pressure-sensitive adhesive films have also been utilized in various fields because of good bonding operation properties. Typical pressure-sensitive adhesive sheets comprise, as a base component, a petroleum-based polymer layer that is superior in durability performances. The polymer layer is then coated on one side, or both sides, with a pressure-sensitive adhesive layer that often contains an acrylic polymer.

In recent years, the increasing environmental consciousness has been directing attention to application of biodegradable resins to the film industry. After disposal, films made of biodegradable resins can be broken down by bacteria and return to soil even buried in a landfill or left to stand under natural environmental conditions. Under these circumstances, there exists a need for pressure-sensitive adhesive films that are biodegradable while maintaining the desired film properties such as weathering resistance, heat resistance, deterioration resistance, moisture proof, printability, die-cutting and dispensing performance.

For example, large end-users such as the supermarket chains have been leading the drive to either more sustainable packaging or for packaging which may be disposed of in scenarios other than landfill. Increasingly, more food packaging for example is now being made from materials such as polylactic acid (PLA) or from so-called Bio-polymers, which may be defined as “Any polymer derived directly or indirectly from biomass”. For example sugar beet can be converted to glyconic acid, which may be subsequently polymerised to polyglyconic acid. Natural polymers which can be derived directly from biomass include polysaccharides, celluloses, pectins and proteins.

Much of this packaging carries a label made from paper, which itself is made from a cellulose base and is therefore also biodegradable and compostable. However the adhesive itself is not compostable, which means that the label must be removed prior to disposal of the package into compost environments. Recent trends in food labelling however, are showing greater use of the “no-label look” where a clear polymeric film label is replacing traditional paper-based or white wet-glue applied labels which effectively hide the product. Naturally, in the case where a product is being packaged with a clear biodegradable packaging film, if the no-label look is required then the printed label will need to be made from components that are transparent and also biodegradable, so that the overall packaging can meet the biodegradation standards.

In addition to this growing trend in the no-label look, new demands on food packaging mean that producers have to provide information on the product's ingredients or nutritional attributes. The increasingly widening range of pack sizes also means that the information provided is different for each pack size and food manufacturers are meeting these challenges with self-adhesive labels, which allow labels to be applied to products late in the production stages. Thus, with the increasing use of sustainable or biodegradable packaging materials, it is a natural progression for the pressure-sensitive label to also be made from such materials. There exists a need for the development of biodegradable adhesives and printing inks to ensure full compliance with the biodegradation/composting standards.

### SUMMARY

One aspect of the present invention relates to a biodegradable multi-layer film. The film comprises a biodegradable core layer and a biodegradable pressure-sensitive adhesive layer, wherein the biodegradable pressure sensitive adhesive layer is positioned to be the outmost layer of said biodegradable multi-layer film or is covered with a removable release liner.

In one embodiment, the biodegradable core layer comprises cellulose.

In a related embodiment, the cellulose is regenerated cellulose.

In another embodiment, the biodegradable core layer comprises polylactic acid (PLA).

In another embodiment, the biodegradable core layer is covered with a biodegradable, printable layer on at least one side of the biodegradable core layer.

In a related embodiment, the biodegradable core layer is covered with the biodegradable, printable layer on both sides.

In another related embodiment, the biodegradable, printable layer comprises a biodegradable polymer selected from the group consisting of biodegradable polyesters, polylactic acid, polyhydroxyalkanoates, polycaprolactones, polybutylene succinate adipate, polybutylene adipate co-terephthalate, polylactic acid/caprolactone co-polymers, biodegradable polyethylene and nitrocellulose.

In another embodiment, the biodegradable multi-layer film further comprises a barrier layer.

In a related embodiment, the barrier layer is a metal layer.

In another related embodiment, the barrier layer is a biodegradable layer.

In another embodiment, the multi-layer film further comprises a biodegradable ink layer.

In a related embodiment, the biodegradable core layer is covered with a biodegradable printable layer and the ink layer is formed on the biodegradable printable layer.

In another embodiment, the biodegradable multi-layer film further comprises a release liner.

In another embodiment, the biodegradable pressure-sensitive adhesive layer comprises a biodegradable polymer selected from the group consisting of biodegradable acrylic polymers, biodegradable polyesters, polylactic acid, polyhydroxyalkanoates, polycaprolactones, polybutylene succinate adipate, polybutylene adipate co-terephthalate, polylactic acid/caprolactone co-polymers, starch, hydrocarbon resins, and natural pine rosins.

Another aspect of the present invention relates to a biodegradable multi-layer film comprising: a biodegradable core layer comprising cellulose or PLA; a biodegradable barrier layer or printable layer on each side of said biodegradable core layer; and a biodegradable pressure sensitive adhesive layer.

In one embodiment, the biodegradable multi-layer film further comprises a metalized layer.

In another embodiment, the biodegradable pressure sensitive adhesive layer is either uncovered on one side with any other layers or covered with a removable release liner.

In another embodiment, the biodegradable pressure-sensitive adhesive layer comprises a biodegradable polymer selected from the group consisting of biodegradable acrylic polymers, biodegradable polyesters, polylactic acid, polyhydroxyalkanoates, polycaprolactones, polybutylene succinate adipate, polybutylene adipate co-terephthalate, polylactic acid/caprolactone co-polymers, starch, hydrocarbon resins, and natural pine rosins.

Another aspect of the present invention relates to a method for producing a multi-layer, biodegradable film with a biodegradable pressure-sensitive adhesive layer and a release liner. In one embodiment, the method comprises laminating a biodegradable layer structure onto a release liner with a biodegradable pressure sensitive adhesive using a extrusion laminator, wherein the biodegradable layer structure comprises a cellulose layer or a PLA layer.

In a related embodiment, the method further comprises the step of covering a biodegradable core layer with a printable cover layer to form the biodegradable layer structure, wherein the biodegradable core layer comprises cellulose and wherein the printable cover layer comprises a polymer selected from the group consisting of biodegradable polyesters polylactic acid, polyhydroxyalkanoates, polycaprolactones, polybutylene succinate adipate, polybutylene adipate co-terephthalate, polylactic acid/caprolactone co-polymers, biodegradable polyethylene and nitrocellulose.

### BRIEF DESCRIPTION OF DRAWINGS

For the purposes of this disclosure, unless otherwise indicated, identical reference numerals used in different figures refer to the same component.

FIG. 1 is a diagram showing an embodiment of a multi-layer, biodegradable film with a pressure-sensitive adhesive layer.

FIGS. 2A and 2B are diagrams showing embodiments of a multi-layer, biodegradable film with a pressure-sensitive adhesive layer and a printable coating layer.

FIGS. 3A-3C are diagrams showing embodiments of a multi-layer, biodegradable film with a pressure-sensitive adhesive layer, a printable coating layer and an ink layer.

FIG. 4 is a diagram showing force-extension curves for a Natureflex™ NVL (NVL) film, a PLA film and a BOPP film.

FIG. 5 is a diagram showing bending stiffness of NVL film, PLA film, BOPP film and a 85 micron thick polyethylene film (PE).

FIG. 6 is a diagram showing dynamic mechanical thermal analysis (DMTA) of NVL film, PLA film and BOPP film.

FIG. 7 is a diagram showing tear initiation resistance of NVL, PLA and BOPP in both machine direction (MD) and transverse direction (TD).

FIG. 8 is a diagram showing film dimension change as a function of temperature, when heating at 2° C./min.

FIG. 9 is a diagram showing film dimension change as a function of temperature, starting at 0° C. and room temperature.

### DETAILED DESCRIPTION

The following detailed description is presented to enable any person skilled in the art to make and use the invention. For purposes of explanation, specific nomenclature is set forth to provide a thorough understanding of the present application. However, it will be apparent to one skilled in the art that these specific details are not required to practice the invention. Description of specific embodiments and applications is provided only as representative examples. This description is an exemplification of the principles of the invention and is not intended to limit the invention to the particular embodiments illustrated.

This description is intended to be read in connection with the accompanying drawings, which are to be considered part of the entire written description of this invention. The drawings are not necessarily to scale and certain features of the invention may be shown exaggerated in scale or in somewhat schematic form in the interest of clarity. In the description, relative terms such as “front,” “back,” “up,” “down,” “top” and “bottom,” as well as derivatives thereof, should be construed to refer to the orientation as then described or as shown in the drawing under discussion. These relative terms are for convenience of description and normally are not intended to require a particular orientation.

The present application relates to a biodegradable, multi-layer film that contains a biodegradable core layer and a pressure sensitive adhesive layer on at least one side of the film. A “biodegradable layer,” as used herein, refers to a polymer layer that can be degraded when exposed to microbial, enzymatic or other biological action into carbon dioxide (CO₂), water and other compounds. The pressure sensitive adhesive layer serves to adhere the biodegradable, multi-layer film to an object. Accordingly, it is positioned to be the outmost layer of the multi-layer film. In some embodiment, the pressure sensitive adhesive layer is covered with a release liner.

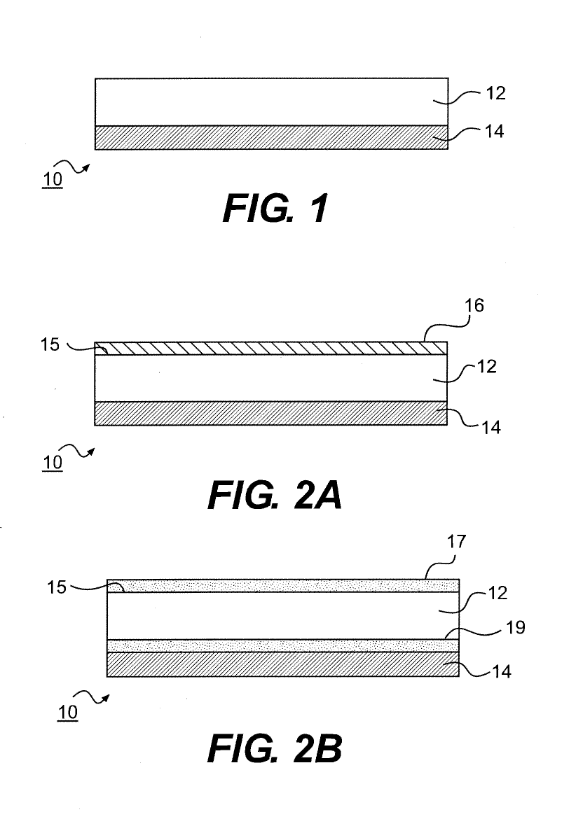

FIG. 1 shows an embodiment of the multi-layer film of the present invention. In this embodiment, the film 10 comprises a biodegradable core layer 12 and a pressure sensitive adhesive layer 14. Preferably, the pressure sensitive adhesive layer 14 is a biodegradable pressure sensitive layer. In one embodiment, the biodegradable core layer 12 comprises PLA or a PLA derivative.

FIG. 2A shows another embodiment of the multi-layer film of the present invention. In this embodiment, the film 10 comprises a biodegradable core layer 12, a pressure sensitive adhesive layer 14 and a printable layer 16. The printable layer 16 may be a continuous layer that completely covers the top surface 15 of the biodegradable core layer 12, or a discontinuous layer that partially cover the top surface 15 of the biodegradable core layer 12. Preferably, the pressure sensitive adhesive layer 14 or the printable layer 16 or both the pressure sensitive adhesive layer 14 and the printable layer 16 are biodegradable. In the embodiment shown in FIG. 2B, the biodegradable core layer 12 is covered with a cover layer (17, 19) on both sides. Each of the cover layers 17 and 19 can be a printable layer or a barrier layer. The pressure sensitive adhesive layer 14 is applied directly on top of layer 19. In a preferred embodiment, the pressure sensitive adhesive layer 14, as well as layers 17 and 19, are biodegradable. In one embodiment, the biodegradable core layer 12 comprises cellulose and the printable layer 16 comprises PLA.

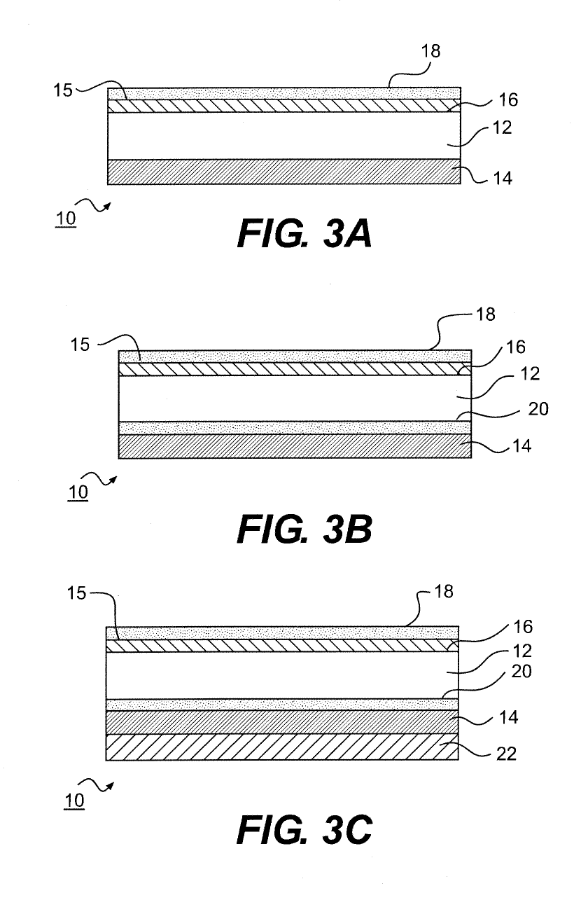

FIG. 3A shows another embodiment of the multi-layer film of the present invention. In this embodiment, the film 10 comprises a biodegradable core layer 12, a pressure sensitive adhesive layer 14, a printable layer 16 and an ink layer 18 printed on top of the printable layer 16. The printable layer 16 may be a continuous layer that completely covers the top surface 15 of the biodegradable core layer 12, or a discontinuous layer that partially cover the top surface 15 of the biodegradable core layer 12. The ink layer 18 may be a continuous layer or a discontinuous layer. The pressure sensitive adhesive layer 14 and/or the printable layer 16 and/or the ink layer are biodegradable. In one embodiment, the pressure sensitive adhesive layer 14, the printable layer 16 and the ink layer are biodegradable layers. In a preferred embodiment, the biodegradable core layer 12 comprises cellulose and the printable layer 16 comprises PLA.

In the embodiment shown in FIG. 3B, the multi-layer film 10 further comprises a layer 20 that is located between the biodegradable core layer 12 and the pressure sensitive adhesive layer 14. Layer 20 can be a printable layer or a barrier layer. In the embodiment shown in FIG. 3C, the multi-layer film 10 further comprises a release liner 22. In one embodiment, the release liner comprises a substrate layer and a releasing layer. Such a release liner can be applied to any of the film structures having a pressure sensitive adhesive layer, such as those shown in FIGS. 1-3.

Preferably, the pressure sensitive adhesive layer 14, the printable layer 16 and layer 20 are biodegradable.

The average thickness of the multi-layer biodegradable film of the present invention is in the range of about 10 to about 100 μm, about 10 to about 70 μm, and from about 20 to about 50 μm. In one embodiment, the multi-layer biodegradable film is a duplex laminated films (i.e. where a single web is laminated onto itself) to provide desired stiffness.

In a preferred embodiment, the multi-layer biodegradable film is compostable according to the EN13432 or ASTM D6400 standard.

### The Biodegradable Core Layer

The biodegradable layer may be made from biodegradable biopolymers, paper, post consumer reclaim (PCR) fibers, and synthetic biodegradable polymers such as biodegradable polyesters, polylactic acid, polyhydroxyalkanoates, polycaprolactones, polybutylene succinate adipate, polybutylene adipate co-terephthalate, polylactic acid/caprolactone co-polymers, biodegradable polyethylene and nitrocellulose.

Biopolymers are polymers that are obtained and/or obtainable from a biological (preferably plant and/or microbial) source and may comprise those organic polymers which comprise substantially carbon, oxygen and hydrogen. Biodegradable biopolymers may be selected from carbohydrates; polysaccharides (such as cellulose, starch, glycogen, hemi-cellulose, chitin, fructan inulin; lignin and/or pectic substances); gums; proteins, optionally cereal, vegetable and/or animal proteins (such as gluten, whey protein, and/or gelatin); colloids (such as hydro-colloids, for example natural hydrocolloids, e.g. gums); other polyorganic acids (such as polylactic acid (PLA), polygalactic acid (PGA) and polyhydroxy-alkanoate (PHA)) effective mixtures thereof; and/or effective modified derivatives thereof.

Cellulose comprises a long unbranched chain of glucose units. The term “cellulose,” as used herein, includes cellulose and cellulose derivatives such as cellulose esters and cellulose ethers.

Starch may comprises native and/or modified starch obtained and/or obtainable from one or more plant(s); may be a starch, starch-ether, starch-ester and/or oxidised starch obtained and/or obtainable from one or more root(s), tuber(s) and/or cereal(s) such as those obtained and/or obtainable from potato, waxy maize, tapioca and/or rice.

Gluten may comprise a mixture of two proteins, gliadin and glutenin whose amino acid composition may vary although glutamic acid and proline usually predominate.

Gums are natural hydro-colloids which may be obtained from plants and are typically insoluble in organic solvents but form gelatinous or sticky solutions with water. Gum resins are mixtures of gums and natural resins.

As used herein the term carbohydrate will be understood to comprise those compounds of formula Cₓ(H₂O)_{y} which may be optionally substituted. Carbohydrates may be divided into saccharides (also referred to herein as sugars) which typically may be of low molecular weight and/or sweet taste and/or polysaccharides which typically may be of high molecular weight and/or high complexity.

Polysaccharides comprise any carbohydrates comprising one or more monosaccharide (simple sugar) units. Homopolysaccharides comprise only one type of monosaccharide and heteropolysaccharides comprise two or more different types of sugar. Long chain polysaccharides may have molecular weights of up to several million daltons and are often highly branched, examples of these polysaccharides comprise starch, glycogen and cellulose.

Polysaccharides also include the more simple disaccharide sugars, trisaccharide sugars and/or dextrins (e.g. maltodextrin and/or cyclodextrin).

Polysaccharides may comprise a polymer of at least twenty or more monosaccharide units and more preferably have a molecular weight (M_{w}) of above about 5000 daltons. Less complex polysaccharides comprise disaccharide sugars, trisaccharide sugars, maltodextrins and/or cyclodextrins. Complex polysaccharides which may be used as biopolymers to form or comprise films of present invention comprise one or more of the following: Starch (which occurs widely in plants) may comprise various proportions of two polymers derived from glucose: amylose (comprising linear chains comprising from about 100 to about 1000 linked glucose molecules) and amylopectin (comprising highly branched chains of glucose molecules).

Glycogen (also known as animal starch) comprises a highly branched polymer of glucose which can occur in animal tissues.

Chitin comprises chains of N-acetyl-D-glucosamine (a derivative of glucose) and is structurally very similar to cellulose.

Fructans comprise polysaccharides derived from fructose which may be stored in certain plants.

Inulin comprises a polysaccharide made from fructose which may be stored in the roots or tubers of many plants.

Lignin comprises a complex organic polymer that may be deposited within the cellulose of plant cell walls to provide rigidity.

Pectic substances such as pectin comprise polysaccharides made up primarily of sugar acids which may be important constituents of plant cell walls. Normally they exist in an insoluble form, but may change into a soluble form (e.g. during ripening of a plant).

Polylactic and/or polygalactic polymers and the like comprise those polymeric chains and/or cross-linked polymeric networks which are obtained from, obtainable from and/or comprise: polylactic acid; polygalactic acid and/or similar polymers and which may be made synthetically and/or sourced naturally.

Other types of polysaccharide derivatives one or more of which may also be used to form (in whole or in part) films of the present invention may comprise any effective derivative of any suitable polysaccharide (such as those described herein) for example those derivatives selected from amino derivatives, ester derivatives (such as phosphate esters) ether derivatives; and/or oxidised derivatives (e.g. acids).

In certain embodiments, the biodegradable core layer is a cellulose layer. In certain embodiment, the biodegradable core layer comprises regenerated cellulose. In other embodiments, the biodegradable core layer is a cellophane layer. In other embodiments, the c biodegradable core layer comprises cellulose diacetate. In another embodiment, the cellulose layer is a transparent layer.

In certain embodiments, the biodegradable core layers are formed from cellulose which is substantially continuous, more preferably non-woven and/or entangled, in structure. In yet other embodiments, the biodegradable core layers are formed from non-microbial cellulose such as cellulose regenerated from a cellulosic dispersion in a non-solvating fluid (such as but not limited to NMMO and/or a mixture of LiCl and DMP). One specific example is “viscose” which is sodium cellulose xanthate in caustic soda. Cellulose from a dispersion can be cast into film by regenerating the cellulose in situ by a suitable treatment (e.g. addition of suitable reagent which for viscose can be dilute sulphuric acid) and optionally extruding the cellulose thus formed. Such cellulose is known herein as regenerated cellulose. In other embodiments, the biodegradable core layer comprises cellulose from a wood source such as wood pulp, preferably at least 90% of the cellulosic material is from a wood source.

In certain other embodiment, the biodegradable core layer comprises PLA or a PLA derivative. In one embodiment, the PLA layer consists of only PLA. In other embodiments, the PLA layer further comprises starch in an amount sufficient to improve the rate of degradation. In some embodiments, the PLA layer comprises about 2% (w/w) to about 20% (w/w) starch.

In certain other embodiments, the PLA layer further comprise a transition metal stearate. Examples of such stearate include, but are not limited to, the stearate salt of aluminum, antimony, barium, bismuth, cadmium, cerium, chromium, cobalt, copper, gallium, iron, lanthanum, lead, lithium, magnesium, mercury, molybdenum, nickel, potassium, rare earths metals, silver, sodium, strontium, tin, tungsten, vanadium, yttrium, zinc and zirconium. In some embodiments, the PLA layer comprises about 0.5% (w/w) to about 5% (w/w) metal stearate.

In certain embodiment, the biodegradable core layer is a compostable core layer. In order for a material to be designated as “compostable,” it must be demonstrated that it will biodegrade and disintegrate in a controlled composting system under standard test conditions. There are various standards, such as EN13432 standard and ASTM D6400-04 standard, covering the criteria for inclusion of biodegradable materials in compost. These standards define the degree of biodegradation that has to occur in a specified timeframe and the levels of disintegration required for the polymer within the compost. This generally means that biodegradable polymers must be used in appropriate forms (e.g. thin films) such that they can breakdown sufficiently in the timeframes specified. In a preferred embodiment, the biodegradable core layer is compostable according to the EN13432 or ASTM D6400 standard.

The biodegradable core layer may further comprises a plasticiser in an amount from about 10% to about 30%, preferably about 20% by weight of the biodegradable core layer. In certain embodiment, the plasticiser is a material which is compatible with food packaging (for example is food contact approved) and/or substantially non-toxic in the amounts used. For example the plastcisier may be selected from glycols, (such as MPG, TEG, PEG), urea, sorbitol, glycerol and/or mixtures thereof in any suitable mixtures and ratios to those skilled in the art. In one embodiment, the plasticiser comprise such as a mixture of sorbitol and glyercol in the respective weight ratio of 60:40 by weight of solids.

The biodegradable core layer may comprise other conventional film additives and/or coatings well known in the art of film making such as those which are compatible with packaging, preferably food packaging and more preferably are food contact approval by the FDA in the US (and/or analogous agencies in other countries). Such additives and/or coatings may comprise softeners, anti-static agents, particulate additives and/or may be tinted or otherwise treated, for example impregnated with one or more other active ingredients, provided such modifications are compatible with the uses of the film as a label as described herein.

The biodegradable core layer has a thickness that is suitable for the intended application of the multi-layer biodegradable film. For example, film intended for labels should have sufficient bending stiffness to enable high speed dispensing. In certain embodiments, the biodegradable core layer has a thickness in the range of about 5-150 μm, about 10-120 μm, about 20-100 μm, about 30-80 μm, or about 40-60 μm. In one embodiment, the biodegradable core layer has a thickness of 45 μm, 50 μm or 55 μm. In certain other embodiments, the thickness of the biodegradable core layer is about 50%-95%, 60%-95%, 70%-95%, 80%-95% or 90%-95% of the total film thickness. In certain other embodiments, the biodegradable core layer is about 50%-95%, 60%-95%, 70%-95%, 80%-95% or 90%-95% by weight of the total film.

In one embodiment, the biodegradable layer comprises paper. In another embodiment, the paper is PCR paper. As used herein, the term “PCR paper” refers to paper made from a cellulose-based material that comprises PCR fibers. Briefly, PCR fibers or a mixture of PCR fibers and virgin paper fibers may be used in conventional paper making processes at the wet mixing stage and are then dried across a drum roll to form the paper sheet. The PCR fibers thereby replace a portion or all of the virgin fibers. In one embodiment, the PCR paper comprises between about 10% and about 80% PCR fibers by total weight of the paper.

In some embodiments, the multi-layer, biodegradable film comprises two biodegradable core layers bonded together by an adhesive layer.

### The Pressure Sensitive Adhesive Layer

The biodegradable core layer is covered at least on one side with a pressure sensitive adhesive layer. In one embodiment, the biodegradable core layer is covered on one side with the pressure sensitive adhesive layer. In another embodiment, the biodegradable core layer is covered on both sides with the pressure sensitive adhesive layer. In some embodiments, the biodegradable core layer is in direct contact with the pressure sensitive adhesive layer. In other embodiments, the biodegradable core layer is separated from the pressure sensitive adhesive layer by one or more other layers, such as a printable layer, a barrier layer or an ink layer.

The pressure-sensitive adhesive layer comprises a pressure-sensitive adhesive composition. The pressure-sensitive adhesive composition used in the pressure-sensitive adhesive layer is not specifically restricted and conventional pressure-sensitive adhesives, such as rubber-based pressure-sensitive adhesives, acrylic pressure-sensitive adhesives, vinyl ether pressure-sensitive adhesives, silicone adhesives and mixtures of two or more thereof, may be used. Such pressure-sensitive adhesive materials are described in sensitive “Adhesion and Bonding”, Encyclopedia of Polymer Science and Engineering, Vol. 1, pages 476-576, Interscience Publishers, 2nd edition, 1985. Suitable pressure-sensitive adhesive materials contain a polymer as a principal constituent, for instance acrylic type polymers, block copolymers, natural or recovered rubbers, styrene butadiene rubbers, random ethylene and vinyl acetate copolymers, ethylene vinyl acrylic terpolymers, polyisobutylene poly(vinyl ethers) etc. The pressure-sensitive adhesive materials are typically characterized by their glass transition temperatures ranging from about −70° C. to about 10° C.

In certain embodiments, the pressure sensitive adhesive compositions comprises an acryl type copolymer and a cross-linking agent.

The acryl type copolymer includes copolymers of one or more alkyl esters of (meth)acrylate, the carbon atom number of the alkyl group being 4 to 18 and one or more of other monomer containing polymerizable ethylenically unsaturated bond, etc.

Examples of the monomers of alkyl esters of (meth)acrylate include methyl ester, ethyl ester, propyl ester, isopropyl ester, butyl ester, isobutyl ester, s-butyl ester, t-butyl ester, pentyl ester, isopentyl ester, hexyl ester, heptyl ester, octyl ester, 2-ethyl hexyl ester, iso-octyl ester, nonyl ester, decyl ester, isodecyl ester, undecyl ester, dodecyl ester, tridecyl ester, tetradecyl ester, hexadecyl ester, octadecyl ester, eicosyl ester, other alkyl radicals with 1 to 30 carbon atoms, straight chain or branch chain alkyl ester with 4 to 18 carbon atoms, and (meth)acrylic cycloalkyl ester (for example, cyclopentyl ester, cyclohexyl ester). These materials may be used either alone or in combination of two or more types. As used herein, the term “(meth)acrylate” refers to acrylate and/or methacrylate.

In certain embodiments, the pressure-sensitive adhesive composition comprises copolymerizable monomers containing an ethylenically unsaturated bond. Examples of the copolymerizable monomer containing an ethylenically unsaturated bond include acrylonitrile, methyl(meth)acrylate, ethyl(meth)acrylate, propyl(meth)acrylate, isopropyl(meth)acrylate, cyclohexyl(meth)acrylate, styrene, α-methyl styrene, vinyl acetate, N-vinyl-2-pyrrolidone, benzyl(meth)acrylate, 2-hydroxyethyl(meth)acrylate, 2-hydroxypropyhmeth)acrylate, acrylic acid, methacrylic acid, itaconic acid, and fumaric acid.

Examples of the cross-linking agent in order to cross-link an acryl type copolymer in the adhesive composition of the present invention include an isocyanate type cross-linking agent including a diisocyanate compound such as hexamethylene diisocyanate, xylylene diisocyanate, tolylene diisocyanate, 2-chloro-1,4-phenyl diisocyanate, trimethylhexamethylene diisocyanate, 1,5-naphthalene diisocyanate and isophorone diisocyanate, a biuret trimer and an isocyanurate type trimer of these diisocyanate compounds, and triisocyanates, epoxy type cross-linking agents, a melamine type cross-linking agent, a metal chelate type cross-linking agents, and adducts of a polyol such as trimethylol propane, and a suitable one can appropriately be selected for use.

The pressure-sensitive adhesive composition may also contain multifunctional monomers for crosslinking purpose. Such multifunctional monomers include, for example, hexane diol di(meth)acrylate, (poly)ethylene glycol di(meth)acrylate, (poly)propylene glycol di(meth)acrylate, neopentyl glycol di(meth)acrylate, pentaerythritol di(meth)acrylate, trimethylol propane tri(meth)acrylate, pentaerythritol tri(meth)acrylate, dipentaerythritol hexa(meth)acrylate, epoxy(meth)acrylate, polyester(meth)acrylate, urethane(meth)acrylate, etc. These multifunctional monomers may be also used either alone or in combination of two or more types. The amount of the multifunctional monomers is preferred to be 30 wt. % or less of the total monomer components from the viewpoint of adhesive property, etc.

In a preferred embodiment, the pressure sensitive adhesive is a biodegradable pressure sensitive adhesive. Examples of such adhesives include, but are not limited to, biodegradable acrylic polymers, biodegradable polyesters, polylactic acid, polyhydroxyalkanoates, polycaprolactones, polybutylene succinate adipate, polybutylene adipate co-terephthalate, polylactic acid/caprolactone co-polymers, starch, hydrocarbon resins, and natural pine rosins.

In one embodiment, the biodegradable pressure sensitive adhesive comprises a hot-melt adhesive based on polycaprolactone polyesters. In another embodiment, the biodegradable pressure sensitive adhesive comprises a biodegradable acrylic polymer.

In a more preferred embodiment, the pressure sensitive adhesive is a compostable pressure sensitive adhesive. In one embodiment, the pressure sensitive adhesive is compostable according to the EN13432 or ASTM D6400 standard.

In other embodiments, the pressure-sensitive adhesive composition further comprises a tackifier resin. Examples of the tackifier resin include a rosin type resin such as rosin, a rosin phenol resin, and its esterified product and its metal salt, a terpene type polymer such as a terperene polymer, a terpene-phenol resin and an aromatic modified terpene resin, a styerene type resin, a coumarone/indene resin, an alkylphenol resin, a xylene resin, a C5 type petroleum resin, C9 type petroleum resin, and an alicyclic hydrogenated resin, among which a natural resin type such as a rosin type resin and a terpene type resin are preferably used because they are excellent in compatibility with an acryl type copolymer and show good adhesive force and an initial tackiness to a receiving object such as paper and various films upon incorporating in the acryl type copolymer.

In one embodiment, the pressure-sensitive adhesive layer further comprises a UV blocker.

In another embodiment, the pressure-sensitive adhesive layer comprises a radiation curable adhesive composition which may be cured by radiation such as X-ray, ultraviolet (UV) light, visible light or electron ray. In one embodiment, the photo curable adhesive composition is a UV-curable adhesive composition.

In certain embodiments, the radiation curable, pressure-sensitive adhesive composition comprises an acrylic adhesive or rubber adhesive, blended with radiation curing type monomer components or oligomer components.

Examples of radiation curing type monomer components for forming the acrylic adhesive include urethane oligomer, urethane(meth)acrylate, trimethylol propanetri(meth)acrylate, tetramethylol methane tetra(meth)acrylate, pentaerythritoltri(meth)acrylate, pentaerythritol tetra(meth)acrylate, dipentaerythritol monohydroxy penta(meth)acrylate, dipentaerythritol hexa(meth)acrylate, 1,4-butane diol di(meth)acrylate, and others. Radiation curing oligomer components include various oligomers of, for example, urethane type, polyether type, polyester type, polycarbonate type, and polybutadiene type, and the component of molecular weight of about 100 to 30000 is preferred. The blending amount of radiation curing monomer component or oligomer component may be properly determined to lower the adhesive force of the adhesive layer depending on the type of the adhesive layer. Generally, in 100 parts by weight of the base polymer such as acrylic polymer composing the adhesive agent, it is preferred to add by 0.1 to 200 parts by weight, more preferably 0.1 to 150 parts by weight.

The pressure sensitive adhesive layer has a thickness that is suitable for the intended application of the multi-layer biodegradable film. In certain embodiments, the pressure sensitive adhesive layer has a thickness in the range of about 1-50 μm, about 2-25 μm, about 2-10 μm, or about 5-20 μm. In one embodiment, the pressure sensitive adhesive layer has a thickness of 1, 2, 5, 10, 15, 20, 25, 30, 40 or 50 μm. In certain other embodiments, the thickness of the pressure sensitive adhesive layer is about 1-20%, 1-10%, 1-5% or 1-2% of the total film thickness.

In one embodiment, the weight of the pressure-sensitive adhesive coating ranges from 5 to 50 g/m². In another embodiment, the weight of the pressure-sensitive adhesive coating ranges from 15 to 35 g/m².

In certain embodiments, the pressure-sensitive adhesive layer is not a continuous layer. For example, the pressure-sensitive adhesive may be present in a pattern of 12 to 80, particularly 24 to 50 lines/cm substrate. The shape of the pattern elements, such as diameter and height of the dots or lines, and hence the adhesive forces are chiefly influenced by the following factors: type of coating process, parameters affecting the coating process (e.g. mesh size and depth in the case of screen printing) and any physical parameters affecting the compound that is applied (e.g. hot-melt adhesive or dispersion adhesive), particularly its viscosity and thixotropy.

The pressure-sensitive adhesive can be applied by using standard caoting techniques, such as curtain coating, gravure coating, reverse gravure printing, offset gravure printing, roller coating printing, brushing, knife-over-roll coating, air-brush roller coating, metering-roller coating, reverse roll coating, roller coating with bottom-action doctor blade, immersion, jet coating, spraying and the like. The pressure-sensitive adhesive may also be applied by an extrusion laminator. The use of these techniques is well known and can be performed effectively by a person skilled in the art. Further information on coating techniques is to be found in “Modern Coating and Drying Technology”, by Edward Cohen and Edgar Gutoff, published by VCH Verlag, 1992.

### The Release Liner

In certain embodiments, the pressure-sensitive adhesive layer is covered by a release liner. In one embodiment, the release liner comprises a substrate layer and a releasing layer formed on the substrate layer. In another embodiment, the pressure-sensitive adhesive layer is transferred to the biodegradable core layer from a release liner with which the biodegradable core layer is combined.

The substrate used in the release liner is not particularly limited and can be suitably selected from compositions conventionally used as the substrate layer of release films. Examples of the substrate layer include films of polyesters such as polyethylene terephthalate, polybutylene terephthalate and polyethylene naphthalate, polyethylene films, polypropylene films, polyvinyl chloride films, polyvinylidene chloride films, polyvinyl alcohol films, ethylene-vinyl acetate copolymer films, polystyrene films, polycarbonate films, polymethylpentene films, polysulfone films, polyether ether ketone films, polyether sulfone films, polyphenylene sulfide films, polyether imide films, polyimide films, fluororesin films, polyamide films, acrylic resin films, norbornene-based resin films and cycloolefin resin films. In one embodiment, the substrate is paper. In another embodiment, the substrate is a Natureflex™ film (Innovia). The thickness of the substrate layer is not particularly limited and suitably selected in accordance with the application. In general, the thickness is in the range of 5 to 150 μm and preferably in the range of 10 to 120 μm, 15 to 75 μm, or 20 to 50 μm. The specific thickness being dependent on the actual application.

In certain embodiments, the substrate layer is subjected to a surface treatment such as oxidation treatment, roughening treatment or primer treatment on one or both faces so that adhesion with the releasing layer formed on the substrate layer is improved. Examples of oxidation treatment include treatment by corona discharge, treatment by plasma discharge, treatment with chromic acid (a wet process), treatment with flame, treatment with heated air and treatment with ozone under irradiation with ultraviolet light. Examples of roughening treatment include sandblasting treatment and treatment with a solvent. The surface treatment is suitably selected in accordance with the type of the substrate layer. In a preferred embodiment, the surface treatment is corona discharge. In another embodiment, the substrate layer comprises a paper layer.

The releasing layer comprises a releasing agent. In certain embodiments, the releasing agent is a silicone-based releasing agent, such as polyorganosiloxanes. The thickness of the releasing agent layer comprising the silicone-based releasing agent is, in general, about 0.01 to 3 μm and preferably 0.03 to 1 μm.

In other embodiments, the releasing agent is a non-silicone-based releasing agent. Examples of releasing agents include, but are not limited to, releasing agents based on compounds having a long chain alkyl group, such as polyvinyl carbamate, alkyd resin-based releasing agents, olefin resin-based releasing agents, rubber-based releasing agents and acrylic releasing agents.

Alkyd resin-based releasing agents typically contain an alkyd resin obtained by condensation of a polyhydric alcohol and a polybasic acid. Examples of polyhydric alcohols include dihydric alcohols such as ethylene glycol, diethylene glycol, triethylene glycol, propylene glycol, trimethylene glycol, tetramethylene glycol and neopentyl glycol, trihydric alcohols such as glycerol, trimethylolethane and trimethylolpropane, and polyhydric alcohols having a functionality of four or greater such as diglycerol, triglycerol, pentaerythritol, dipentaerythritol, mannit and sorbit. The polyhydric alcohol may be used singly or in combination of two or more.

Examples of polybasic acids include aromatic polybasic acids such as phthalic anhydride, terephthalic acid, isophthalic acid and trimellitic anhydride, aliphatic saturated polybasic acids such as succinic acid, adipic acid and sebacic acid, aliphatic unsaturated polybasic acids such as maleic acid, maleic anhydride, fumaric acid, itaconic acid and citraconic anhydride, and polybasic acids obtained by the Diels-Alder reaction such as addition products of cyclopentadiene and maleic anhydride, addition products of terpene and maleic anhydride and addition products of rosin and maleic acid. The polybasic acid may be used singly or in combination of two or more.

The olefin resin-based releasing agents may contain a crystalline olefin-based resin. In one embodiment, the crystalline olefin-based resin is crystalline polypropylene-based resin.

The rubber-based releasing agents may contain a natural rubber-based resin or a synthetic rubber-based resin such as butadiene rubber, isoprene rubber, styrene-butadiene rubber, methyl methacrylate-butadiene rubber and acrylonitrile-butadiene rubber.

The acrylic releasing agents may contain a (meth)acrylic ester-based copolymer having a crosslinking functional group In one embodiment, the (meth)acrylic ester-based copolymer has a weight-average molecular weight to 300,000 or greater.

In another embodiment, the releasing agent further comprises an electrically conductive material such as carbon fibers.

### The Printable Layer and Ink Layer

In certain embodiments, the biodegradable core layer is covered, at least partially, with a printable layer. As used herein, the term “printable layer” or “printable coating” refers to a layer or coating that is receptive to ink. Such a layer or coating is constructed with a material or materials, or is subjected to special treatments, that enable the placement of an image on the layer or coating, especially through offset printing, gravure, flexography, screen process printing, letterpress printing, and the use of laser printers, laser copiers, other toner-based printers and copiers, and thermal transfer printers (e.g., resin ribbon thermal transfer, wax ribbon thermal transfer, and resin/wax thermal transfer). Moreover, the image composition may be composed of any of the inks or other compositions typically used in these printing processes (e.g., UV curable ink, toner ink compositions and ribbon compositions).

In one embodiment, the printable layer and the pressure sensitive adhesive layer are on the same side of the biodegradable core layer. Briefly, the biodegradable core layer is first covered with the printable layer. Prints are made on top of the printable layer and the printed layer is then covered with the pressure sensitive adhesive layer. In another embodiment, the printable layer and the pressure sensitive adhesive layer are applied on different side of the biodegradable core layer.

In certain embodiments, the printable layer comprises a water dispersible polymer, for example a water dispersible acrylic or urethane polymer. In the present specification, an “acrylic polymer” means a (co)polymer obtained by the free-radical addition polymerization of at least one (meth)acrylic type monomer and optionally of other vinylic or allylic compounds. It is essential that this acrylic polymer should be able to provide a smooth film-formed and reasonably open surface.

A wide variety of acrylic polymers are able to fulfill this requirement. Suitable acrylic polymers are homopolymers of (meth)acrylic acid or alkyl(meth)acrylate, the alkyl radical having 1 to 10 carbon atom, or copolymers of two or more of the said (meth)acrylic type monomer and optionally of other vinylic or allylic compounds.

As said above, a water dispersible urethane polymer may also suitably be used. As with the acrylic polymer, it is essential that this urethane polymer should be able to provide a smooth film-formed and reasonably open surface.

A wide variety of urethane polymers are able to fulfill this requirement. Suitable urethane polymers are for example the reaction product of an isocyanate-terminated polyurethane prepolymer formed by reacting at least an excess of an organic polyisocyanate, an organic compound containing at least two isocyanate-reactive groups and an isocyanate-reactive compound containing anionic salt functional groups (or acid groups which may be subsequently converted to such anionic salt groups) or non-ionic groups and an active hydrogen-containing chain extender.

The printable layer may also comprises an ethylenically unsaturated compound. The ethylenically unsaturated compound is selected to be miscible in the wet stage in the aqueous phase and to be compatible in the dry stage with the water dispersible polymer itself. Consequently, the ethylenically unsaturated compound acts as a plasticiser for the surface layer once hardened allowing the easy penetration of the ink thereto.

In some embodiments, the ink is a UV curable ink and the ethylenically unsaturated compound is able to react with unsaturated components of the ink when the printed film is submitted to radiations in order to cure the ink.

This reaction between the ethylenically unsaturated compounds of the printable coating and the unsaturated compounds of the radiation curable ink forms chemical bonds between those compounds and simultaneously crosslinks the printable coating with the ink.

Preferably, the ethylenically unsaturated compound contains 1 to 10 ethylenical bonds per molecule and still more preferably 2 to 5 ethylenical bonds per molecule.

Suitable ethylenically unsaturated compounds are the ester derivatives of α- or β-ethylenically unsaturated acids, such as acrylic or methacrylic acids, itaconic or citraconic acids, maleic or fumaric acids, etc. with polyols or alkoxylated polyols.

The suitable polyols include saturated aliphatic diols such as ethylene glycol, diethylene glycol, triethylene glycol, propylene glycol, dipropylene glycol, tripropylene glycol, butylene glycols, neopentyl glycol, 1,3- and 1,4-butane diols, 1,5-pentane diol, 1,6-hexanediol and 2-methyl-1,3 propanediol. Glycerol, 1,1,1-trimethylolpropane, bisphenol A and its hydrogenated derivatives may also be used. The suitable alkoxylated polyols include the ethoxylated or propoxylated derivatives of the polyols listed above.

Examples of ethylenically unsaturated compounds which can be used according to the invention are polyfunctional acrylates such as difunctional acrylates, such as 1,4-butane diol diacrylate, 1,6-hexane diol diacrylate, neopentyl glycol diacrylate, triethylene glycol diacrylate, polyethylene glycol diacrylate, tripropylene glycol diacrylate, 2,2-dionol diacrylate, bisphenol A diacrylate, etc., trifunctional acrylates such as pentaerythritol triacrylate, trimethylolpropane triacrylate, etc. tetrafunctional acrylates, etc.

It is to be understood that the methacrylate derivatives corresponding to these acrylate derivatives could also be used. Moreover, it has been found that polyallyl derivatives such as tetraallyloxyethane are also suitable. Preferably ethoxylated trimethylolpropane triacrylate (EBECRYL 1160 from UCB CHEMICALS) is used.

The amount of the ethylenically unsaturated compound can be of from about 2 to about 90% by weight of the acrylic polymer, and preferably is from about 2 to about 15% (in the present specification, all percentages are dry weight based).

In order to improve the hardness and/or water resistance of the printable coating, a crosslinking agent may advantageously be added to the printable coating. Such a crosslinking agent should be chosen so as the printable coating, once hardened, allows the easy penetration of the radiation curable ink thereto.

Coordinating metal ligands which can form stable coordinated structures with carboxy or carbonyl functionality perfectly fulfill this requirement. Ammonium zirconium carbonate (stabilized or not) is particularly preferred. The amount of the crosslinking agent can be up to 5% by weight of the water dispersible polymer, and preferably is from 1 to 5% by weight of the water dispersible polymer.

The printable layer may contain other additional agents, if necessary, for preventing the blocking of one sheet to another, and for improving the sheet running property, antistatic property, nontransparency property, etc. These additional agents are generally added in a total amount not exceeding about 40% by weight of the water dispersible polymer. As said additional agent, for example, a pigment such as polyethylene oxide, silica, silica gel, clay, talc, diatomaceous earth, calcium carbonate, calcium sulfate, barium sulfate, aluminum silicate, synthetic zeolite, alumina, zinc oxide, titanium oxide, lithopone, satin white, etc. and cationic, anionic and nonionic antistatic agents, etc. may be used.

The printable layer may also comprise waxes and other conventional additives as required to modify the slip and block resistance of the coating. Such additives may be selected from one or more of the following and/or mixtures thereof fatty acids e.g. Behenic Acid; fatty acid ester amide (amide wax) e.g. that available commercially under the trade name Lanco wax E2S; hydrogenated castor oil mono and diesters of phosphoric acid e.g., that available commercially under the trade name Crodafos S2; maleic acids; similar acids and/or ester, and/or salts thereof and/or other simple derivatives thereof.

In one embodiment, the printable layer is applied as an aqueous dispersion at about 0.5 to about 2.5 g/m² on the substrate by the method of roll coating, blade coating, spray coating, air knife coating, rod bar coating, reverse gravure, etc. on the substrate and then dried, for example, in a hot air oven.

After the drying step, the printable layer comprises thus the water dispersible polymer, smoothly crosslinked by the crosslinking agent and, included in the acrylic polymer matrix, the ethylenically unsaturated compound. Such a coating allows easy penetration of the radiation curable ink into the printable coating as well as its subsequent reaction with the ethylenically unsaturated compound.

In another embodiment, the printable layer, such as a PLA layer, is co-extruded with the biodegradable core layer. In yet another embodiment, the printable layer, such as a PLA layer, is laminated on top of the biodegradable core layer, such as a cellulose layer.

In certain embodiments, the printable layer is a biodegradable layer. In a preferred embodiment, the printable layer is a compostable coating. In a more preferred embodiment, the printable layer is compostable according to the EN13432 or ASTM D6400 standard. Materials suitable for the biodegradable layer include, but are not limited to, biodegradable polyesters such as EcoFlex (BASF) and Biomax (DuPont), biodegradable polyethylene, PLA and PLA derivatives.

In certain embodiments, the printable coating has a thickness of about 1-20 μm, about 2-10 μm, or about 5 μm.

Before applying the printable layer, the surface of the biodegradable core layer can be first pretreated in a conventional manner with a view to improve its adhesiveness. For this purpose, it is possible, for example, to pretreat the biodegradable core layer by corona discharge. It should be understood, however, that all known techniques aiming at improving the surface of a sheet-like item with a view of the application of a composition, may be suitable.

In certain embodiments, a primer is used as an intermediate between the biodegradable core layer and the barrier layer or printable layer to provides a high level of adherence. Examples of suitable primers include, but are not limited to, polyethylene imine or polyurethane acrylate primers crosslinked by isocyanate, epoxy, aziridine or silane derivatives may be cited. The primer resin may be applied by conventional coating techniques, e.g., by a gravure roll coating method. The resin is conveniently applied as a dispersion or as a solution. Economically it would be preferable to apply the resin as a dispersion in water. Aqueous dispersion techniques have the added advantage that there is no residual odor due to the solvent present which is generally the case when an organic solvent is used. However, when using aqueous techniques, it is usually necessary to heat the film a higher temperature to dry off the dispersant than with systems using an organic solvent or dispersant. Furthermore, the presence of a surfactant, which is generally used to improve the dispersion of the coating in water, tends to reduce the adhesion between the resin and the base film. Thus, it is also possible to apply the resin from an organic solvent or dispersant. Examples of suitable organic solvent include alcohols, aromatic hydrocarbon solvents, such as xylene, or mixtures of such solvents as is appropriate.

The film with a printable layer may be printed by conventional methods such as offset printing, gravure, flexography, screen process printing and letterpress printing. In one embodiment, the printable layer is printed with a radiation curable ink and subsequently radiation cured.

Ink formulations for radiation curing contains generally pigments, vehicle, solvent and additives. The solvents in these systems are low-viscosity monomers, capable of reacting themselves (i.e., used as reactive diluents). The vehicle is usually composed of a resin derived from unsaturated monomers, prepolymers or oligomers such as acrylates derivatives which are able to react with the ethylenically unsaturated compound of the surface layer. For a UV ink, the “additives” contain a large amount of photoinitiators which respond to the photons of UV light to start the system reacting.

In one embodiment, the UV ink formulation contains 5-20% pigment, 20-35% prepolymers, 10-25% vehicle, 2-10% photoinitiators and 1-5% other additives. As noted earlier, all the percentages are based on dry weight. In another embodiment, the ink is an electron beam curable ink and contains no photoinitiator.

The low viscosity monomers, sometimes termed diluents, are capable of chemical reactions which result in their becoming fully incorporated into the ultimate polymer matrix.

The vehicle provides the “hard resin” portion of the formulation. Typically, these are derived from synthetic resins such as for example, urethanes, epoxides, polyesters which have been modified by reaction with compounds bearing ethylenic groups such as for instance (meth)acrylic acid, hydroxyethyl(meth)acrylate reaction product of caprolactone with unsaturated compounds bearing a hydroxyl group, and the like. Appropriate adjustments could be made in the selection of the prepolymers and monomers used in order to achieve the required viscosities for the different methods of application.

10138] In another embodiment, the printable layer is printed with a biodegradable ink. Examples of biodegradable ink include, but are not limited to, water-based ink compositions, nitrocellulose-based ink compositions, and PLA or PHA based ink compositions, such as those described in U.S. Patent Application Publication No. 20050215662, which is incorporated herein by reference. Examples of biodegradable inks include Flexiprint MV from the Flint Group (Luxembourg), Aquabio and Saga C BIO both from Sun Chemicals (Parsippany, N.J.). After printing, the ink composition forms an ink layer on top of the printable layer.

### The Barrier Layer

The multi-layer biodegradable film may contain one or more barrier layers. Commonly used barrier layer materials include aluminum, ethylene vinyl alcohol (EVOH), nitro-cellulose, polyvinylidene chloride (PVdC), copolymers such as vinyl chloride/vinyl acetate copolymer, and silicon based materials such as silicon oxides (SiOₓ) and silicon nitride (Si₃N₄).

In certain embodiments, the biodegradable core layer is covered on one side or both sides with a barrier layer to improve barrier properties and sealability. In some embodiments, the biodegradable layer is regenerated cellulose and is coated on one or both sides with a vinyl chloride/vinyl acetate copolymer layer. In certain embodiments, the regenerated cellulose biodegradable layer has a thickness of about 10-100 μm and preferably about 20-50 μm; the copolymer cover layer has a thickness of about 0.2-10 μm, preferably about 0.5-5 μm. In certain embodiments, the copolymer coated biodegradable layer has a water vapor permeability of about 20-30 g/100 in², 24 hrs measured at 100° F., 90% RH by the ASTM E96 standard or about 350-400 g/m². 24 hrs measured at 38° C., 90% RH by the ASTM E96 standard; and an oxygen permeability of about 0.05-0.5 cc/100 in² 24 hrs bar, measured at 75° F., 0-5% RH or about 1-10 cc/m² 24 hrs bar, measured at 23° C., 0% RH by the ASTM F1927 standard.

In certain other embodiments, the biodegradable core layer is covered on one side or both sides with nitro-cellulose barrier layer to improve barrier properties and sealability. In other embodiments, the biodegradable layer is regenerated cellulose and is covered on one or both sides with a nitro-cellulose layer. In another embodiment, the biodegradable layer is a PLA layer and is covered on one or both sides with a nitro-cellulose layer. In certain embodiments, the regenerated cellulose biodegradable layer has a thickness of about 10-100 μm and preferably about 20-50 μm; the nitro-cellulose cover layer has a thickness of about 0.2-10 μm, preferably about 0.5-5 μm. In certain embodiments, the nitro-cellulose coated biodegradable layer has a water vapor permeability of about 0.3-30 g/100 in², 24 hrs measured at 100° F., 90% RH by the ASTM E96 standard or about 200-1800 g/m². 24 hrs measured at 38° C., 90% RH by the ASTM E96 standard; and an oxygen permeability of about 0.05-0.5 cc/100 in² 24 hrs bar, measured at 75° F., 0-5% RH or about 1-10 cc/m² 24 hrs bar, measured at 23° C., 0% RH by the ASTM F1927 standard.

In certain embodiments, the barrier layer also serves as a printable layer. Vise versa, a printable layer may also serve as a barrier layer if the printable layer possesses the barrier properties (e.g., water vapor permeability or oxygen permeability) required for a particular application.

In certain embodiments, the biodegradable core layer is coated on one side or both sides with a polyvinylidene chloride (PVdC) barrier layer to improve barrier properties and sealability. In other embodiments, the biodegradable layer is regenerated cellulose and is coated on one or both sides with a PVdC layer. In certain embodiments, the regenerated cellulose biodegradable layer has a thickness of about 10-100 μm and preferably about 20-50 μm. In certain embodiments, the PVdC cover layer has a thickness of about 0.2-10 μm, preferably about 0.5-5 μm; the PVdC coated biodegradable layer has a water vapor permeability of about 0.2-20 g/100 in², 24 hrs measured at 100° F., 90% RH by the ASTM E96 standard and an oxygen permeability of about 0.05-0.5 cc/100 in² 24 hrs bar, measured at 75° F., 0-5% RH or about 1-10 cc/m² 24 hrs bar, measured at 23° C., 0% RH by the ASTM F1927 standard.

In one embodiment, the barrier layer is a metal layer formed on a surface of the biodegradable core layer or on the surface of another barrier layer such as a PVdC layer. The metal layer may cover the full surface or only a portion of the surface of the biodegradable core layer or another barrier layer.

Metallization processes are known to the person skilled in the art. The usual method here uses metal, such as aluminum, deposited from the vapor in vacuo onto a web substrate. The metal deposits on the web substrate, thus forming a thin film. By way of example, a prefabricated web substrate, such as a biodegradable polymer film, can be introduced into a vacuum chamber and a vacuum in the range from 10⁻⁴ to 10⁻⁵ bar can be generated with the aid of suitable pumps. The metal, such as aluminum, is then heated to a temperature in the range from 1400 to 1500° C., thus producing a cloud of metal vapors in the vacuated space through which the polymer film is passed. A very thin metal layer is thus deposited on the surface of the polymer film. It is preferable here that one entire surface of the polymer film is metalized. The thickness of the metal film can be adjusted by varying the temperature, vacuum, geometry of the vacuum chamber, and speed of the polymer film passing through the metal vapor. The thickness of the metal film can be measured either electrically or optically.

In one embodiments, the biodegradable core layer comprises PLA or a PLA derivative and is covered with a metal barrier layer on one surface. In another embodiment, the biodegradable core layer comprises cellulose and is coated on one or two sides with a PVdC coating. One of the PVdC coated surface is further covered with a metal barrier layer. In one embodiment, the PVdC coated, metal covered biodegradable layer has a water vapor permeability of about 0.1-1 g/100 in², 24 hrs measured at 100° F., 90% RH by the ASTM E96 standard and an oxygen permeability of about 0.02-0.2 cc/100 in² 24 hrs bar, measured at 75° F., 0-5% RH.

In another embodiment, the barrier layer comprises a metal oxide (e.g., AlOₓ) or a semimetal oxide (e.g., SiOₓ). The coating process can be carried out by way of example by chemical vapor deposition (CVD) or physical vapor deposition (PVD). These processes are known to the person skilled in the art. By way of example, it is possible to vaporize aluminum in vacuo and to deposit AlOₓ by adding a certain amount of oxygen. In the case of silicon, the material can be vaporized with the aid of an electron beam.

In certain embodiments, the barrier layer is a biodegradable barrier layer. In a preferred embodiment, the barrier layer is a compostable barrier layer. In a more preferred embodiment, the barrier layer is compostable according to the EN13432 or ASTM D6400 standard. In one embodiment, the biodegradable barrier layer comprises a polymer selected from the group consisting of nitrocellulose, co-polyesters, PGA, PBS, starches, lactic acid/caprolactone co-polymers, polyhydroxyalkanoates, biodegradable polyethylene (PE), polypropylene (PP), polybutene (PB) and co-polymers, and mixtures thereof. In some embodiments, the barrier layer further comprises a wax and/or a particulate filler, such as clay, to further enhance the barrier function.

The barrier layer may has a thickness in the range of about 0.1-20 μm, 0.2-10 μm, and about 0.5-5 μm.

### Method of Making the Multi-Layer, Biodegradable Film

The multi-layer, biodegradable film can be produced using equipments commonly used in the film industry. In certain embodiments, the method comprises: laminating a biodegradable film onto a release liner with a biodegradable pressure sensitive adhesive. In one embodiment, the biodegradable film comprises a PLA core layer. In another embodiment, the biodegradable film comprises a cellulose core layer covered at least on one side with a printable cover layer. In another embodiment, the method further comprises the step of printing on the laminated multi-layer biodegradable film with a biodegradable ink, wherein the printing step may be performed prior to, or after the laminating step. In another preferred embodiment, the release liner comprises paper.

The present invention is further illustrated by the following example which should not be construed as limiting. The contents of all references, patents and published patent applications cited throughout this application are incorporated herein by reference.

### EXAMPLES

### Example 1

### Comparison of Film Mechanical Properties

One of the key properties of a film in labelling is its performance under tension. Films must be able to withstand the tensions needed to give good layflat during adhesive coating and must hold their dimensional stability when subjected to heat. The amount of tension a film can withstand is also related to the stiffness or “modulus” of a film. This is important in dispensing where the facestock requires a sufficient bending stiffness to enable it to easily release from the liner onto the article being labelled.

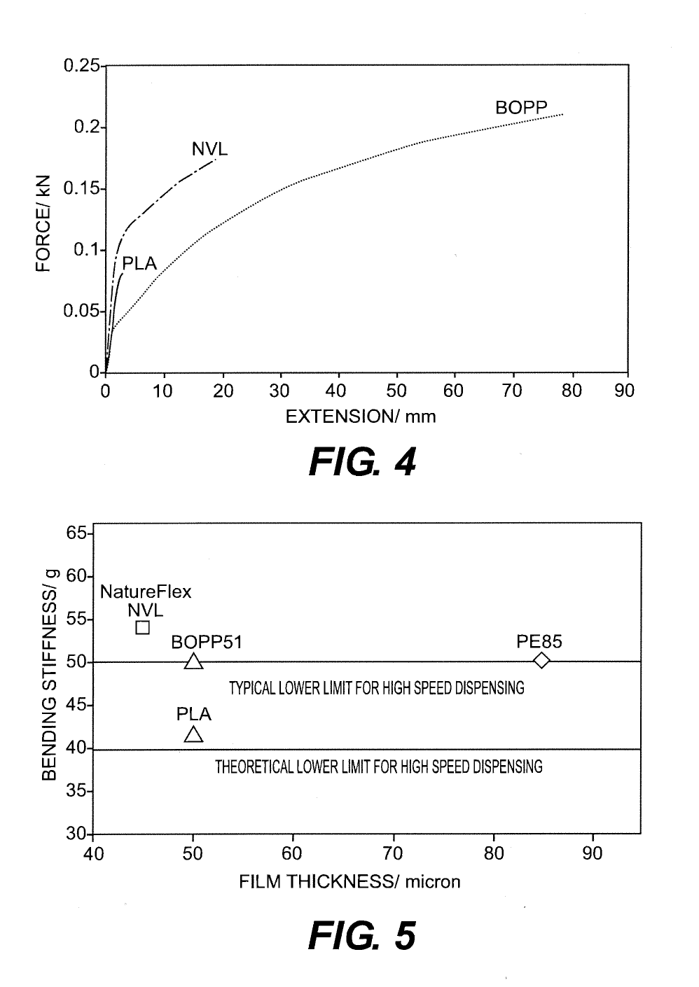

Comparison of thermal and mechanical properties was made using Innovia's 45 micron thick Natureflex™ NVL film (NVL), a 50 micron thick PLA film (PLA) and a 50 micron thick bi-axially oriented polypropylene (BOPP) film made by the bubble process. FIG. 4 shows the force-extension curves for NVL, PLA and BOPP measured in tension using a tensometer. A high initial slope in the curve indicates a high modulus and a large extension means that the film can be stretched a long way prior to breaking. FIG. 4 clearly shows that both NVL and PLA are stiffer than a 50 micron BOPP, with the relative stiffness being in the order NVL>PLA>BOPP. BOPP is known to dispense efficiently, thus it is envisaged that both NVL and PLA would dispense easily.

From the tensile force-extension curve it can also be seen that PLA is relatively brittle compared to the other films, having only a very low extension at break. NVL allows for some extensibility prior to breaking (up to 20 mm) whilst BOPP has a high extension to break. The two new materials therefore have a higher resistance to deformation than BOPP which is good indication of ease of conversion during adhesive lamination.

The theoretical dispensing performance of a film can be further highlighted by measuring bending stiffness. Whilst not directly related to the tensile modulus given by a stress-strain curve, bending stiffness is arguably a better measure of the ability of a film to dispense. The bending stiffness of the NVL, PLA, BOPP and a 85 micron thick PE film were measured using a handle-ometer. FIG. 5 shows that the relative stiffness is in the order of NVL>BOPP (=PE 85)>PLA and that both NVL and PLA have above the recognised lower limit of bending stiffness for high speed dispensing.

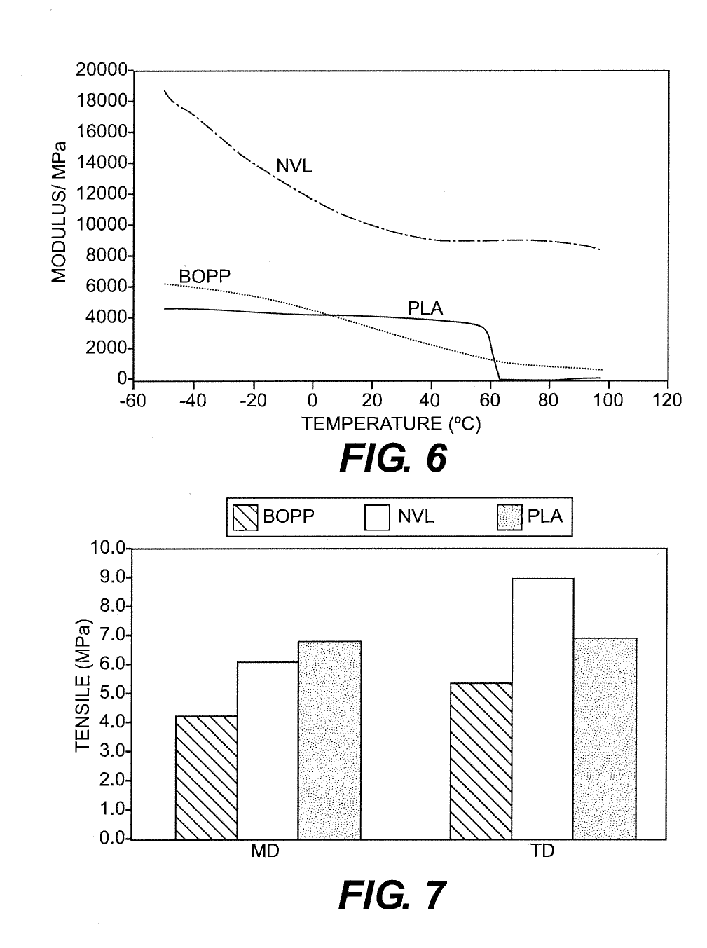

Another important factor to consider is the response of a film when subjected to heat, particularly as the film will need to withstand the often elevated temperatures experienced during printing, through drying ovens or heat emitted by UV curing lamps. Dynamic mechanical thermal analysis is often used to study how a film's modulus (stiffness) changes with temperature. FIG. 6 shows tensile DMTA scans for NVL, PLA and BOPP, from −50° C. to +100° C. All three films show a gradual decrease in modulus with increasing temperature, with very high moduli being shown at sub-zero temperatures. As the temperature increases in the range 20° C. to 100° C., dramatic differences can be observed in the moduli of the three films. NVL gives virtually flat performance in this range, whilst BOPP continues to show a gradual lowering of its modulus as the classical softening behaviour of a polyolefin is observed in this range. PLA, however shows a dramatic loss of modulus at 60° C. which can be attributed to the glass transition temperature of the material (T_{g}). T_{g} is associated with the enabling of large scale molecular rotation and movement where the polymers chains effectively come out of their locked-in or “frozen” state and the polymer exhibits a transition from glassy to rubbery behaviour. The data shows that NVL is very stable at the typical temperature that might be observed in a printing press. BOPP shows lower thermal stability and care would need to be taken not to allow PLA to approach such temperatures in case of potential print registration issues.

One area where BOPP has shown to have excellent performance is in die-cutting. As opposed to paper, oriented polypropylenes show high resistance to tearing, thus enabling labels with high quality edge appearance after punch die-cutting. The tear initiation resistance of the three films is shown in FIG. 7. Clearly both NVL and PLA have significantly higher tear resistance than BOPP, thus their die-cutting performance might be expected to be similar if not even better than a typical BOPP.

In another experiment, the thermal and mechanical properties of Innovia BOPP film and Natureflex™ cellulose film grades and a competitor ploylactic acid (PLA) film were compared (Table 1). The mechanical and thermal properties of the films are shown in Tables 2 and 3.

TABLE 1
Sample details

| Test | | | | |
|---|---|---|---|---|
| Samples | | Thickness | | Sample |
| No. | Source | (microns) | Structure | Description |
| 001 | Plastic | 40 | 3 Layer | Earthfirst PLA 40 |
| | Suppliers/ | | coextruded, melt | |
| | Sidaplax | | blown PLA | |
| 002 | Innovia | 51 | 5 layer | BOPP (CPA51) |
| | Films | | coextruded, | |
| | | | biaxially | |
| | | | oriented PP with | |
| | | | print receptive | |
| | | | coating layer | |
| 003 | Innovia | 45 | 2 side coated | Natureflex ™ NVL |
| | Films | | cellulose film | (645E975) |
| 004 | Innovia | 45 | 2 side coated | White Natureflex ™ |
| | Films | | cellulose film | (645E979) |

TABLE 2
Machine Direction (MD) Tensile Properties

| Tensile | Strain Rate | Sample No. | | | |
|---|---|---|---|---|---|
| Property | (%/min) | 001 | 002 | 003 | 004 |
| Elongation | 50 | 3 | 92 | 21 | 17 |
| at Break | 100 | 2 | 90 | 19 | 16 |
| (%) | 200 | 3 | 86 | 23 | 17 |
| Tensile | 50 | 67.0 | 176 | 177 | 178 |
| Strength | 100 | 61.8 | 181 | 148 | 163 |
| (MPa) | 200 | 63.3 | 170 | 167 | 164 |
| Young's | 50 | 3780 | 2290 | 7410 | 7930 |
| Modulus | 100 | 3400 | 2420 | 6760 | 7400 |
| (MPa) | 200 | 3380 | 2380 | 7200 | 7220 |
| 1% Secant | 50 | 3410 | 2260 | 6920 | 7420 |
| Modulus | 100 | 2840 | 2380 | 6390 | 6940 |
| (Mpa) | 200 | 2460 | 2340 | 6730 | 6870 |
| Load At | 50 | 80.4 | 224.8 | 182.8 | 179.1 |
| Break (N) | 100 | 83.5 | 226.8 | 181.0 | 183.9 |
| | 200 | 85.5 | 225.9 | 195.9 | 189.0 |

TABLE 3
Transverse Direction (TD) Tensile Properties

| Tensile | Strain Rate | Sample No. | | | |
|---|---|---|---|---|---|
| Property | (%/min) | 001 | 002 | 003 | 004 |
| Elongation | 50 | 3 | 109 | 61 | 55 |
| at Break | 100 | 3 | 107 | 57 | 58 |
| (%) | 200 | 3 | 104 | 61 | 56 |
| Tensile | 50 | 78.8 | 169 | 89.8 | 86.1 |
| Strength | 100 | 66.6 | 172 | 86.4 | 79.5 |
| (MPa) | 200 | 66.4 | 164 | 97.0 | 85.1 |
| Young's | 50 | 4410 | 2450 | 4120 | 4400 |
| Modulus | 100 | 3560 | 2420 | 3860 | 3920 |
| (MPa) | 200 | 3420 | 2360 | 4370 | 4170 |
| 1% Secant | 50 | 4080 | 2320 | 3820 | 4030 |
| Modulus | 100 | 3010 | 2330 | 3570 | 3590 |
| (Mpa) | 200 | 2640 | 2270 | 4080 | 3870 |
| Load At | 50 | 82.7 | 215.4 | 94.3 | 88.3 |
| Break (N) | 100 | 84.9 | 214.7 | 105.8 | 93.4 |
| | 200 | 85.6 | 216.7 | 111.6 | 95.7 |

A frequency sweep was carried out at 25° C. on a Dynamic Mechanical Analyser (DMA). The modulus or “stiffness” increases at increasing frequencies for all film types in the test range of 0.01 to 80 Hz. Following the frequency sweep, a temperature sweep at fixed frequency (3 Hz) was carried out. For the PLA and BOPP films (samples 001 and 002), the loss modulus (and tan delta—tan delta is the ratio of loss modulus to storage modulus) exhibited a peak at temperatures corresponding to the glass transition temperatures of the respective polymers. For PLA film, the peak temperature was slightly higher for the TD sample than for the MD sample possibly due to orientation factors. Neither cellulose film exhibited this behavior. The, if anything, tended to exhibit a minimum rather than a peak.

Thermogravimetric Analysis (TGA) revealed a single weight loss event for both PLA and BOPP films when heated under nitrogen. The weight loss profile of the Natureflex™ films was more complex than that of PLA or BOPP. The PLA film completely degraded at a lower temperature than BOPP film. The weight losses observed in the Natureflex™ films correspond to loss of softener followed by carbonisation of the cellulose (loss of water to leave the carbon skeleton behind) and finally conversion of the carbonised cellulose to carbon dioxide after the admission of air at 750° C. The residue relates to the titanium dioxide (TiO₂) for the white films (samples 001 and 004).

Differential scanning calorimetry (DSC) reveals the thermal transitions that occur within the various films. PLA (sample 001) exhibits a glass transition (Tg) at about 60° C. followed by “cold” crystallisation and crystalline perfection prior to melting (Tm) at above 165° C. BOPP exhibits only a Tm above 160° C. and Natureflex™ films exhibit no thermal transitions though the initial heat run contains evidence that softener is lost at elevated temperatures.

When thermal transitions (Tg and Tm) occur, there are accompanying dramatic changes in other properties of the film, including changes in volume and changes in mechanical properties. These changes will be observed as either dramatic expansion or shrinkage of the film with an accompanying dramatic change in the stiffness (modulus) and tensile strength of the film. Elongation to break might also alter dramatically in passing through a transition temperature. Loss of softener (as in the case of the Natureflex™ films) has a less dramatic effect, though can be expected to make the film more brittle.

In summary, the experimental data showed that Natureflex™ films have a higher modulus and hence are stiffer than either BOPP or PLA films allowing lower gauge films to be used in any given application. Natureflex™ films do not undergo any thermal transitions therefore there are no dramatic property changes observed over a wide temperature range.

### Example 2

### UV Printing Capabilities of Biodegradable Film

Samples of Natureflex 45E946, CPA51 and CA51 have been supplied in order to determine the UV printing capabilities of cellulose 45E946 label film against BOPP label film CPA51 and CA51 (Table 4). Both UV Screen and UV Flexo printing were carried out using an Adelco screen printer with standard screen mesh 120 and the R.K Proofer flexo hand roller. The printing results are shown in Tables 5 and 6.

TABLE 4
Sample details

| Samples No. | Sample Type | Sample Description |
|---|---|---|
| 001 | Film | Natureflex ™ 45E946 |
| 002 | Film | BOPP (CPA51) |
| 003 | Film | BOPP (CA51) |

TABLE 5
UV Flexo Printing

| | | | | % | | |
|---|---|---|---|---|---|---|
| | | | | Ink | | |
| Film | Ink | | Curing | Pull | Coin | |
| Type | Colour | Supplier | Conditions | Off | Scratch | X-Hatch |
| 45E946 | White | Sericol | 125 W/1 pass | 40 | Poor | Poor |
| | | | 125 W/2 pass | 0 | Poor | Poor |
| | | | 200 W/1 pass | 0 | Poor | Good |
| | | | 200 W/2 pass | 0 | Poor | Good |
| | | | 300 W/1 pass | 0 | Marring | Good |
| | | | 300 W/2 pass | 0 | Good | Good |
| 45E946 | Orange | Sericol | 125 W/1 pass | 90 | Poor | Poor |
| | | | 125 W/2 pass | 70 | Poor | Good |
| | | | 200 W/1 pass | 40 | Marring | Good |
| | | | 200 W/2 pass | 5 | Good | Borderline |
| | | | 300 W/1 pass | 0 | Good | Borderline |
| | | | 300 W/2 pass | 0 | Good | Good |
| CPA51 | White | Sericol | 125 W/1 pass | *50 | Poor | Poor |
| | | | 125 W/2 pass | *20 | Poor | Poor |
| | | | 200 W/1 pass | 0 | Marring | Good |
| | | | 200 W/2 pass | 0 | Marring | Good |
| | | | 300 W/1 pass | 0 | Good | Good |
| | | | 300 W/2 pass | 0 | Good | Good |
| CPA51 | Orange | Sericol | 125 W/1 pass | *50 | Poor | Poor |
| | | | 125 W/2 pass | *20 | Poor | Poor |
| | | | 200 W/1 pass | 0 | Marring | Good |
| | | | 200 W/2 pass | 0 | Marring | Good |
| | | | 300 W/1 pass | 0 | Good | Good |
| | | | 300 W/2 pass | 0 | Good | Good |
| CA51 | White | Sericol | 125 W/1 pass | 0 | Poor | Poor |
| | | | 125 W/2 pass | 0 | Poor | Good |
| | | | 200 W/1 pass | 0 | Marring | Borderline |
| | | | 200 W/2 pass | 0 | Marring | Good |
| | | | 300 W/1 pass | 0 | Good | Good |
| | | | 300 W/2 pass | 0 | Good | Good |
| CA51 | White | Sericol | 125 W/1 pass | 0 | Poor | Good |
| | | | 125 W/2 pass | 20 | Poor | Good |
| | | | 200 W/1 pass | 10 | Marring | Poor |
| | | | 200 W/2 pass | 0 | Good | Good |
| | | | 300 W/1 pass | 0 | Good | Good |
| | | | 300 W/2 pass | 0 | Good | |

Conditions: 40 (feet per inch)
*Top surface of ink lifted.

TABLE 6
UV Screen Printing
UV Screen Printing

| | | | | % | | |
|---|---|---|---|---|---|---|
| | | | | Ink | | |
| Film | Ink | | Curing | Pull | Coin | |
| Type | Colour | Supplier | Conditions | Off | Scratch | X-Hatch |
| 45E946 | White | Sericol | 125 W/1 pass | 0 | Poor | Borderline |
| | | | 125 W/2 pass | 0 | Poor | Borderline |
| | | | 200 W/1 pass | 0 | Marring | Good |
| | | | 200 W/2 pass | 0 | Good | Good |
| | | | 300 W/1 pass | 0 | Marring | Good |
| | | | 300 W/2 pass | 0 | Good | Good |
| 45E946 | Orange | Sericol | 125 W/1 pass | 40 | Poor | Poor |
| | | | 125 W/2 pass | 30 | Marring | Poor |
| | | | 200 W/1 pass | 20 | Poor | Poor |
| | | | 200 W/2 pass | 0 | Good | Good |
| | | | 300 W/1 pass | 0 | Good | Good |
| | | | 300 W/2 pass | 0 | Good | Good |
| CPA51 | White | Sericol | 125 W/1 pass | 10 | Poor | Poor |
| | | | 125 W/2 pass | 0 | Poor | Poor |
| | | | 200 W/1 pass | 0 | Good | Good |
| | | | 200 W/2 pass | 0 | Good | Good |
| | | | 300 W/1 pass | 0 | Good | Good |
| | | | 300 W/2 pass | 0 | Good | Good |
| CPA51 | Orange | Sericol | 125 W/1 pass | not | Poor | Poor |
| | | | | dry | | |
| | | | 125 W/2 pass | not | Poor | Poor |
| | | | | dry | | |
| | | | 200 W/1 pass | 30 | Poor | Poor |
| | | | 200 W/2 pass | 0 | Good | Good |
| | | | 300 W/1 pass | 10 | Good | Good |
| | | | 300 W/2 pass | 0 | Good | Good |
| CA51 | White | Sericol | 125 W/1 pass | not | Poor | Poor |
| | | | | dry | | |
| | | | 125 W/2 pass | 0 | Poor | Borderline |
| | | | 200 W/1 pass | 0 | Marring | Good |
| | | | 200 W/2 pass | 0 | Good | Good |
| | | | 300 W/1 pass | 0 | Good | Good |
| | | | 300 W/2 pass | 0 | Good | Good |
| CA51 | White | Sericol | 125 W/1 pass | 20 | Poor | Poor |
| | | | 125 W/2 pass | 0 | Poor | Poor |
| | | | 200 W/1 pass | 0 | Poor | Poor |
| | | | 200 W/2 pass | 0 | Good | Good |
| | | | 300 W/1 pass | 0 | Good | Good |
| | | | 300 W/2 pass | 0 | Good | Good |

Conditions: Standard 120 Mesh Screen
Not dry: The ink still wet

As shown in Tables 5 and 6, with the curer set at 300 watts all three films exhibited good adhesion, scratch and X-hatch, the films exhibited slight marring of the surface in some cases. Reducing the curer to 200 watts did not significantly affect the ink adhesion, but had a slightly negative effect on scratch and X-hatch. At 125 watts adhesion, scratch and x-hatch were compromised in some cases the curer failed to dry the wet ink. These data show that Natureflex 45E946 performed well when printed with both UV techniques. Ink adhesion, scratch and x-hatch on Natureflex 45E946 were as good as those on BOPP films.

### Example 3

### Shrinkage Properties of Biodegradable Film

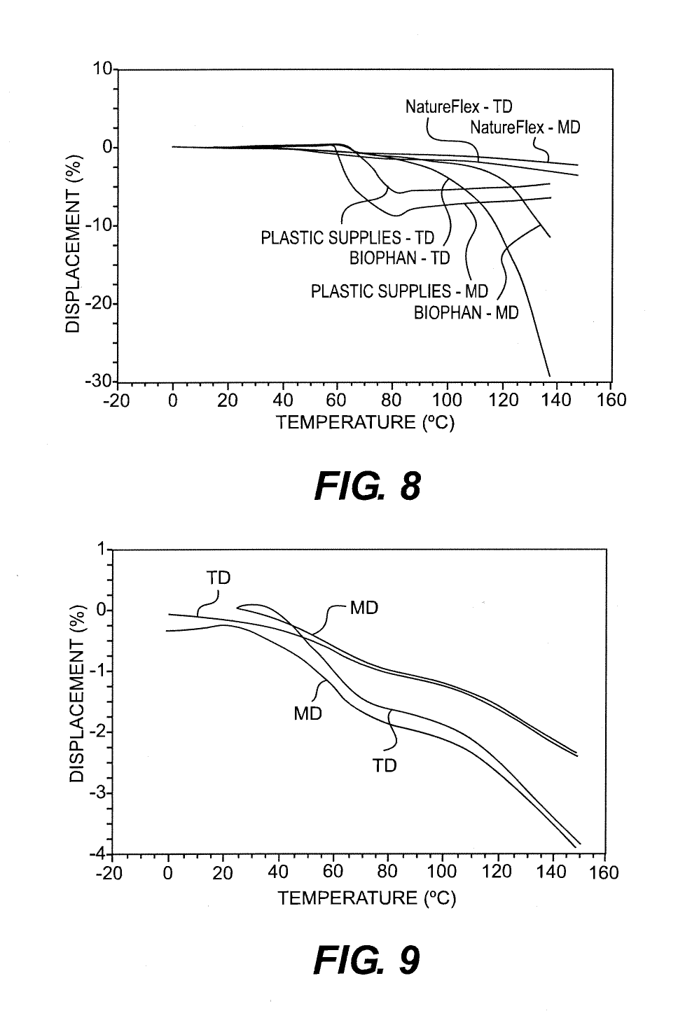

Thermomechanical analysis (TMA) was carried out using a sample of Natureflex 645E946 film (a 45 micron thick, 2 side coated cellulose film). The results were compared against historical data on PLA films from Plastic Supplies and Biophan. Briefly, a strip was cut from the Natureflex 645E946 film in the machine direction and loaded into the DMA, set to a constant force of 0.001N. After measuring the length, the film was heated at 2° C. and the resulting dimension change recorded. Repeating for a strip cut in the transverse direction allows any orientation effects to be seen. FIG. 8 shows the shrinkage curves of Natureflex 645E946, as well as the shrinkage curves of PLA films from Plastic Supplies and Biophan, obtained in an earlier test. FIG. 9 shows the effects of precooling the cellophane film to 0° C. The data show that the Natureflex film exhibits greater dimensional stability than the PLA films at temperatures higher than the glass transition temperature of the PLA films. However, the loss of volatile compounds from the cellophane results in this exhibiting higher levels of shrinkage at temperatures below the glass transition temperature of the PLA films.

### Example 4

### Lamination of Biodegradable Films on Paper Backing with a Biodegradable Adhesive

Objective: To laminate 1 reel of metallised natureflex and 1 reel of white natureflex to a glassine paper backing web using a biodegradable adhesive. Both reels were 1020 mm wide and 1000 m in length.

Trial Parameters:

Coater: In-house engineered

Speed: 17 m/min

Drying Temps: 60° C.

Adhesive: Water based Acrylic (Biodegradable)

Adhesive CWT: 17 gms dry weight

Tension: Film 20 lbs, Glassine paper 40 lbs at nip entry Backing Web: 60 gm Glassine paper standard release

Film Type: Metallised Natureflex™ 645E975, White Natureflex™ 645EXP9E975

A flappy edge on the north side of the white Natureflex™ film caused the laminate to crease severely at the normal output speed of 30 m/min. Various tension and roller adjustments on the coater made no improvement to the creasing. The creasing disappeared, however, when the coater was slowed down gradually to 17 m/min. The metallised Natureflex™ was run at the 17 m/min through the nip with no creasing. Both the 1×1200 m reel of white Natureflex^{TM} 645EXP9E075 and the 1×1000 m reel of metallised Natureflex™ 645E975 were converted successfully.

During the test, the reels were unpacked immediately before use. Once the reel has been laminated, the finished reel was put on to the wracks without being wrapped and stayed in the wracks until slitting took place, usually 1 to 2 days (can be longer). Immediately after slitting conversion of the cellulose substrate, reels should be packed suitably to protect from moisture.

The above description is for the purpose of teaching the person of ordinary skill in the art how to practice the present invention, and it is not intended to detail all those obvious modifications and variations of it which will become apparent to the skilled worker upon reading the description. It is intended, however, that all such obvious modifications and variations be included within the scope of the present invention, which is defined by the following claims. The claims are intended to cover the components and steps in any sequence which is effective to meet the objectives there intended, unless the context specifically indicates the contrary.

What is claimed is:

1. A biodegradable multi-layer film, comprising:
a biodegradable core layer; and
a biodegradable pressure sensitive adhesive layer, wherein said biodegradable pressure sensitive adhesive layer is positioned to be the outmost layer of said biodegradable multi-layer film or is covered with a removable release liner.

2. The multi-layer film of claim 1, wherein said biodegradable core layer comprises cellulose.

3. The multi-layer film of claim 2, wherein said cellulose is regenerated cellulose.

4. The multi-layer film of claim 1, wherein said biodegradable core layer comprises polylactic acid (PLA).

5. The multi-layer film of claim 1, wherein said biodegradable core layer is covered with a biodegradable, printable layer on at least one side of said biodegradable core layer.

6. The multi-layer film of claim 5, wherein said biodegradable core layer is covered with said biodegradable, printable layer on both sides.

7. The multi-layer film of claim 6, wherein said biodegradable, printable layer comprises a polymer selected from the group consisting of biodegradable polyesters polylactic acid, polyhydroxyalkanoates, polycaprolactones, polybutylene succinate adipate, polybutylene adipate co-terephthalate, polylactic acid/caprolactone co-polymers, biodegradable polyethylene and nitrocellulose.

8. The multi-layer film of claim 1, further comprising a barrier layer.

9. The multi-layer film of claim 8, wherein said barrier layer is a metal layer.

10. The multi-layer film of claim 8, wherein said barrier layer is a biodegradable layer.

11. The multi-layer film of claim 1, further comprising a biodegradable ink layer.

12. The multi-layer film of claim 11, wherein said biodegradable core layer is covered with a biodegradable printable layer and said ink layer is formed on said biodegradable printable layer.

13. The multi-layer film of claim 1, wherein said release liner comprises a paper substrate layer.

14. The multi-layer film of claim 1, wherein said biodegradable pressure-sensitive adhesive layer comprises a biodegradable polymer selected from the group consisting of biodegradable acrylic polymers, biodegradable polyesters, polylactic acid, polyhydroxyalkanoates, polycaprolactones, polybutylene succinate adipate, polybutylene adipate co-terephthalate, polylactic acid/caprolactone co-polymers, starch, hydrocarbon resins, and natural pine rosins.

15. A biodegradable multi-layer film, comprising:
a biodegradable core layer comprising cellulose or PLA;
a biodegradable barrier layer or printable layer on each side of said biodegradable core layer; and
a biodegradable pressure sensitive adhesive layer.

16. The biodegradable multi-layer film of claim 15, further comprising a metalized layer.

17. The biodegradable multi-layer film of claim 15, wherein said biodegradable pressure sensitive adhesive layer is either uncovered with any other layers or covered with a removable release liner.

18. The biodegradable multi-layer film of claim 15, wherein said biodegradable pressure-sensitive adhesive layer comprises a biodegradable polymer selected from the group consisting of biodegradable acrylic polymers, biodegradable polyesters, polylactic acid, polyhydroxyalkanoates, polycaprolactones, polybutylene succinate adipate, polybutylene adipate co-terephthalate, polylactic acid/caprolactone co-polymers, starch, hydrocarbon resins, and natural pine rosins.

19. A method for producing a multi-layer, biodegradable film with a pressure sensitive adhesive layer and a release liner, comprising:
laminating a biodegradable layer structure onto a release liner with a biodegradable pressure sensitive adhesive using a extrusion laminator, wherein said biodegradable layer structure comprises a cellulose layer or a PLA layer.

20. The method of claim 19, further comprising:
covering a biodegradable core layer with a printable cover layer to form said biodegradable layer structure, wherein said biodegradable core layer comprises cellulose and wherein said printable cover layer comprises a polymer selected from the group consisting of biodegradable polyesters polylactic acid, polyhydroxyalkanoates, polycaprolactones, polybutylene succinate adipate, polybutylene adipate co-terephthalate, polylactic acid/caprolactone co-polymers, biodegradable polyethylene and nitrocellulose.
